(19) United States
(12) Patent Application Publication
(10) Pub. No.: US 2016/0084573 A1
(43) Pub. Date: Mar. 24, 2016

(54) Ignition-Source-Free Heat Tunnel

(71) Applicant: RJG LABS INC., Scarborough (CA)

(72) Inventor: Gary Sugar, Toronto (CA)

(21) Appl. No.: 14/888,769

(22) PCT Filed: May 5, 2014
(86) PCT No.: PCT/CA2014/050425

§ 371 Date: Nov. 3, 2015

Related U.S. Application Data
(60) Provisional application No. 61/819,957, filed on May 6, 2013.

(51) Int. Cl. F26B 15/12; F26B 3/30; F27B 9/06; F26B 23/10

(52) U.S. Cl. CPC F26B 15/12; F26B 23/10; F26B 3/305; F27B 9/063; F27B 9/068

(57) ABSTRACT

A method and apparatus for maintaining or elevating the temperature of one or more parts in an automated liquid painting or powder coating system, in an area that is required to be ignition-source-free, through the use of a heat-retaining, ignition-source-free tunnel, i.e. an ignition-source-free heat tunnel.

### CROSS-REFERENCE

This application claims priority to U.S. Provisional Patent Application No. 61/819,957 filed May 6, 2013, which is incorporated herein by reference.

### FIELD OF THE INVENTION

The following relates generally to automated coating systems, and more particularly to methods and apparatuses for maintaining or elevating the temperature of one or more parts coated in an automated liquid painting system or powder coating system, adjacent to a hazardous location in such automated liquid painting system or powder coating system.

### BACKGROUND OF THE INVENTION

In many jurisdictions, applicable fire, electrical or other safety regulations classify spray booths, including liquid spray paint booths and powder spray booths in which a combustible liquid or powder is applied, to be hazardous locations. To address possible fire or explosion concerns, these regulations require a designated space, sometimes of three or more feet, around each spray booth opening to be free of any potential ignition source.

Further, in many coating systems, an oven, whether a pre-heat oven or a cure oven, is considered to be a possible ignition source. Accordingly, in many coating systems an ignition-source-free space is required between each such spray booth and oven.

Most existing solutions leave these ignition-source-free spaces as open air. However, parts travel through many automated coating systems at relatively low line speeds. Where such automated coating systems require parts to be hot to be properly coated, it may not be possible to properly coat the parts on such systems as the parts will cool excessively by the time the parts travel through this required ignition-source-free space.

### SUMMARY OF THE INVENTION

In aspects, methods and apparatuses are provided to maintain or elevate the temperature of one or more parts in an automated coating system, in the space and time the part takes to travel through an ignition-source-free space through the use of a heat-retaining, ignition-source-free tunnel, i.e. an ignition-source-free heat tunnel.

In one embodiment, the ignition-source-free heat tunnel is located upstream of a spray booth to maintain or increase the temperature of the part after the part is formed or heated in a pre-heat oven, and before the part enters the spray booth. In another embodiment, the ignition-source-free heat tunnel may be used on the downstream side of the spray booth to maintain or increase the temperature of the part so as to aid in the curing of the coated part in the downstream cure oven.

For example, in an automated powder coating system, the ignition-source-free heat tunnel could be utilized in the space between the pre-heat oven and the powder spray booth to maintain or raise the temperature of the part after exiting the pre-heat oven before the part enters the powder spray booth. In further aspects, the ignition-source-free heat tunnel could be utilized in the space after the powder spray booth and before the cure oven to maintain or raise the heat in the part before the part enters the cure oven.

In application in an automated powder coating system, the ignition-source-free heat tunnel comprises an insulated tunnel that is free of any potential ignition source, which tunnel is open at each end along the length of the tunnel through which the part travels. In embodiments, the tunnel length may be between about two feet and about five feet. The walls of the tunnel are insulated to maintain heat within the ignition-source-free heat tunnel. The opening at each end of the tunnel through which the part travels may be restricted or partially capped to reduce air flow and maintain the heat within the tunnel and while at the same time allowing the part to pass through.

Optionally, heat may be added to the ignition-source-free heat tunnel so as to maintain or even increase the temperature of the part or parts travelling through the ignition-source-free heat tunnel.

Some forming machines, such as pultruders and extruders, use heated oil to heat the die of the forming machine. In one embodiment, the ignition-source-free heat tunnel may be heated using one or more heat exchangers which take heat from the heated forming machine oil, or from one or more independent oil heating systems, i.e. one or more oil heater and pump systems that are separate from the forming machine.

As an alternative to, or in addition to, a heated oil system, heat may also be supplied to the ignition-source-free heat tunnel by one or more suitable heating technologies such as convection, resistive electrical, infra-red, near-infra-red, ultra-violet, microwave, induction, and radio-frequency.

Where heat is supplied to the ignition-source-free heat tunnel, the heat may originally be generated by, and supplied to the ignition-source-free heat tunnel as exhaust from one or more of the pre-heat oven and the cure oven in the automated coating system.

Where heat is added to the ignition-source-free heat tunnel, the temperature of the ignition-source-free heat tunnel may be controlled by one or more closed-loop feedback systems which regulate one or both of the heat being added to the ignition-source-free-heat tunnel and the flow of air through it.

Embodiments may incorporate one or more programmable logic control systems such that the one or more programmable logic control systems of the apparatus are inter-linked with controls of the coating machine such that the ignition-source-free heat tunnel and the coating machine operate effectively in unison as a single production system.

The ignition-source-free heat tunnel may optionally be split along the length of its longitudinal axis, for example using a hinge, so as to allow easy access to the interior of the tunnel. The open tunnel would also allow the ignition-source-free heat tunnel to be removed from an automated coating system, or would allow an entire automated coating system (including the ignition-source-free heat tunnel) to be moved from around the part, for example in an in-line pultrusion painting system.

Further, the ignition-source-free heat tunnel may have one or more access doors or other access openings to the open air to allow access to the interior of the heat tunnel for servicing or to add ventilation to the interior of the ignition-source-free heat tunnel, where each such opening may be fully or partially closed through the use of a door, gate or damper or similar conventional means.

### BRIEF DESCRIPTION OF THE DRAWINGS

The features of the embodiments will become more apparent in the following detailed description in which reference is made to the appended drawings wherein:

FIG. 1 shows a side view of two ignition-source-free heat tunnels in a coating system;

FIG. 2 shows an end view of an embodiment of the ignition-source-free heat tunnel;

FIG. 3 shows an end view of an embodiment of the open ignition-source-free heat tunnel; and

FIG. 4 shows a section of an embodiment of the ignition-source-free heat tunnel.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The figures illustrate in schematic form an example embodiment of the present invention where the ignition-source-free heat tunnel method and apparatus is applied in an automated coating system. The present description is to be considered an exemplification of the principles of the disclosure and is not intended to limit the disclosure to the details of construction and the arrangements of components set forth in the following description or illustrated in the drawing. It is to be understood that other embodiments may be utilized and structural changes may be made without departing from the scope of the present invention.

While the present disclosure may be susceptible to embodiment in different forms, there is shown in the drawing, and described herein in detail, an embodiment with the understanding that the present description is to be considered an exemplification of the principles of the disclosure and is not intended to limit the disclosure to the details of construction and the arrangements of components set forth in the following description or illustrated in the drawing. It is to be understood that other embodiments may be utilized and structural changes may be made without departing from the scope of the present invention.

The drawings illustrate embodiments of a method and apparatus to maintain the heat of a part or to increase the heat of the part in an automated coating system through the use of an ignition-source-free heat tunnel.

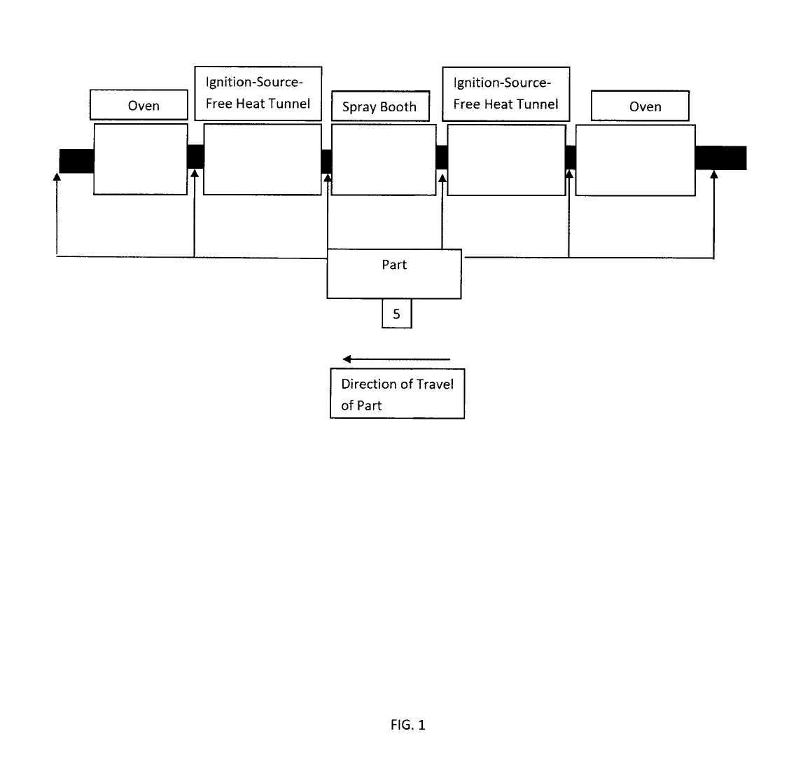

FIG. 1 shows a side view of two ignition-source-free heat tunnels [1] and [2]. One ignition-source-free heat tunnel [1] is located after the oven [4] which heats the part [5] prior to the part being coated in the spray booth [3] in the automated coating system. The part [5] travels through and exits the oven [4], and then travels through the ignition-source-free heat tunnel [1]. The part [5] then exits the ignition-source-free heat tunnel [1] and then enters the spray booth [3] where it is coated.

FIG. 1 shows a second ignition-source-free heat tunnel [2] located downstream of the spray booth [3] and before the cure oven [6] on the automated coating system.

In FIG. 1, the part [5] is shown as a continuous lineal part; however, one or more discrete parts may be conveyed by conventional means on the automated coating system through one or more ignition-source-free heat tunnels.

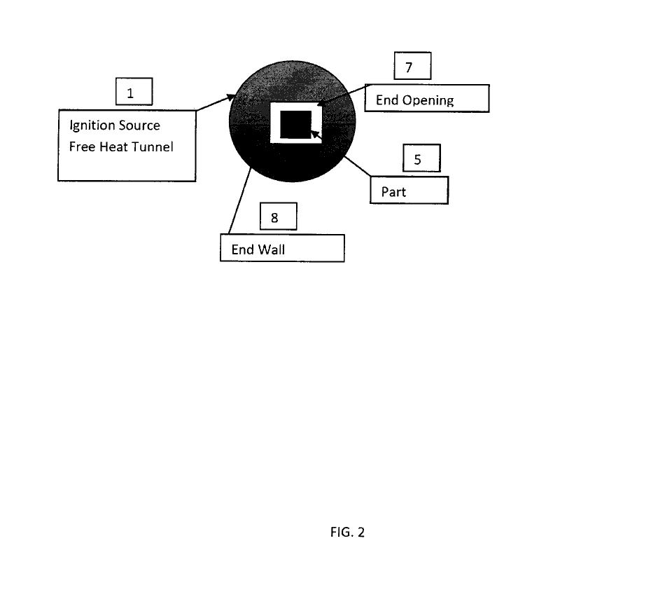

FIG. 2 shows an end view of the ignition-source-free heat tunnel [1] with the part [5] in the ignition-source-free heat tunnel [1]. The opening [7] at the end of the ignition-source-free heat tunnel is restricted in size such that it is partially closed forming an end wall [8], but large enough to allow the part [5] to travel through the end of the ignition-source-free heat tunnel while at the same time restricting air-flow and maintaining heat within the ignition-source-free heat tunnel. However, to adjust air-flow as desired for the desired level of heat within the ignition-source-free heat tunnel, the size of the opening at either end or both ends of the ignition-source-free heat tunnel can be smaller to restrict air-flow, or can be larger (to the point where there is no end wall) to permit more air-flow, if desired.

While the part [5] is depicted in the Figures to be square in profile shape, the part can have any profile shape. Further, while the ignition-source-free heat tunnel [1] is depicted as round in cross-sectional shape, it can be square, rectangular, or of any other cross-sectional shape.

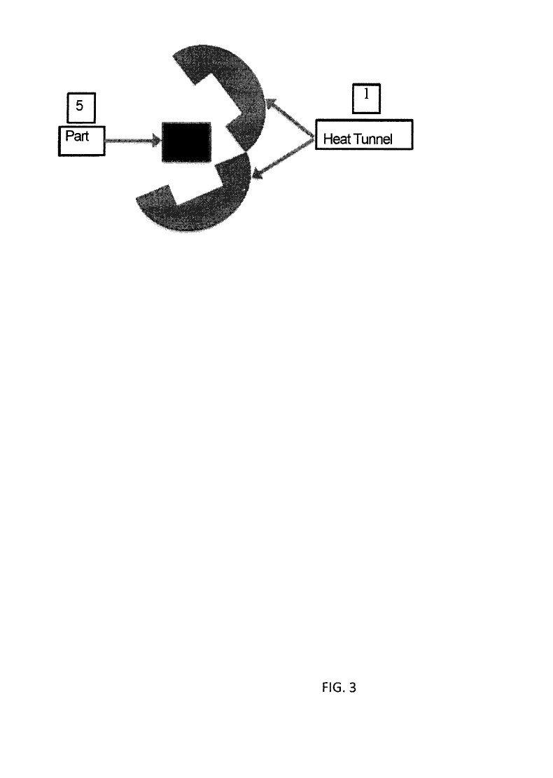

FIG. 3 shows the end view of the open ignition-source-free heat tunnel [1] with the part still in place.

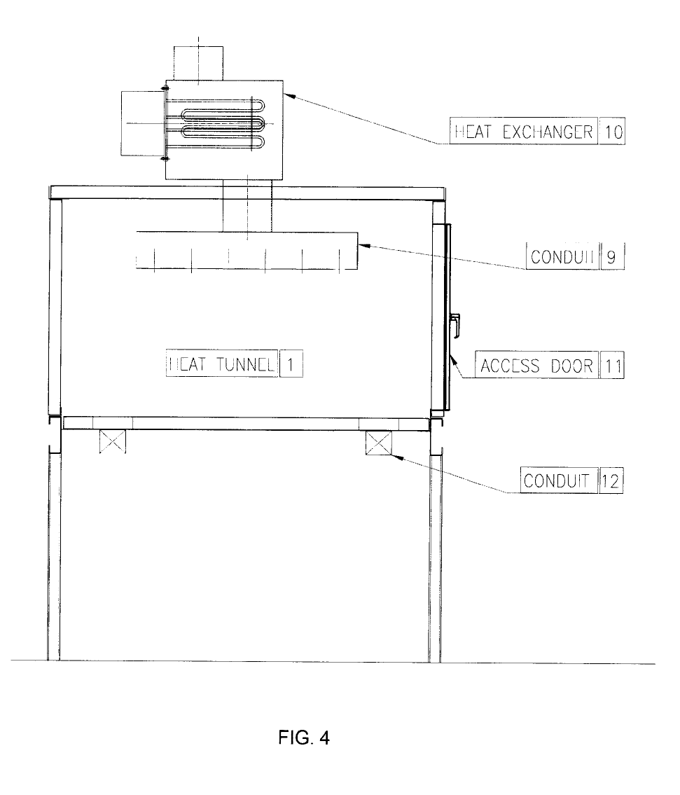

FIG. 4 shows a section of the ignition-source-free heat tunnel [1]. A conduit [9] supplies heat to the inside of ignition-source-free heat tunnel [1]. In embodiments, the conduit conveys heated air generated by, and supplied to, the ignition-source-free heat tunnel as exhaust from one or more of the pre-heat oven and the cure oven in the automated coating system. In another embodiment, the said conduit [9] supplies heat to the ignition-source-free heat tunnel as exhaust from one or more of suitable heating technologies such as convection, resistive electrical, infra-red, near-infra-red, ultra-violet, microwave, inductive, and radio-frequency.

In further embodiments, the said conduit [9] is heated by one or more heat exchangers located in the conduit [9] which heat exchangers take heat from a heated liquid. FIG. 4 shows the heat exchangers [10] within the conduit [9]; however, one or more heat exchangers can be located on one or more of the exterior and interior surfaces of the ignition-source-free heat tunnel.

While one conduit [9] is shown in FIG. 4, embodiments may include one or more such conduits, and such conduit or conduits can be located on one or more of the sides, top, bottom and around the periphery of the ignition-source-free heat tunnel [1].

FIG. 4 shows an opening or access door [11] to the interior of ignition-source-free heat tunnel [1]. However, the ignition-source-free heat tunnel [1] may include no opening or access door, or more than one opening or access door.

FIG. 4 shows a conduit [12] which exhausts air from inside the ignition-source-free heat tunnel [1] to the outside. In another embodiment, the conduit [12] returns cooled oil from the heat exchanger [10] to the oil heat source. While one conduit [12] is shown on the bottom of the ignition-source-free heat tunnel [1], one or more such conduits may be provided, and such conduit or conduits can be located on one or more of the sides or bottom or around the periphery of the ignition-source-free heat tunnel [1].

Further, a plurality of such conduits may be provided wherein one or more of such conduits supplies heat from one or more of the said heat sources and/or media.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1) A method for maintaining or elevating the surface temperature of a part or parts in an automated coating system, the method comprising:
delivering the part or parts through a tunnel that is free of potential ignition-sources, that is, an ignition-source-free heat tunnel.

2) The method of claim 1, wherein heat is supplied to the ignition-source-free heat tunnel;

3) The method of claim 2, wherein the heat supplied to the ignition-source-free heat tunnel is produced by one or more conventional heating technologies comprising at least one member selected from the group consisting of convection, resistive electrical, infra-red, near-infra-red, ultra-violet, microwave, induction, and radio-frequency.

4) The method of claim 2, wherein heat is supplied to the ignition-source-free heat tunnel using heated oil and one or more heat exchangers.

5) The method of claim 2, wherein the heat supplied to the ignition-source-free heat tunnel is supplied as exhaust from at least one member from the group comprising of a pre-heat oven and a cure oven in an automated coating system.

6) The method of claim 2, wherein the heat supplied to the ignition-source-free heat tunnel is controlled by one or more closed-loop feedback temperature control systems.

7) The method of claim 1, wherein the temperature within the ignition-source-free heat tunnel is regulated through the introduction of ambient air from outside the ignition-source-free heat tunnel through one or more openings in one or more of the side walls or one or more of the end walls of the ignition-source-free heat tunnel, or a combination thereof.

8) The method of claim 7, wherein the ambient air supplied to the ignition-source-free heat tunnel is controlled by one or more closed-loop feedback temperature control systems.

9) The method of claim 7, wherein one or both of ambient air and heated air is moved into the ignition-source-free heat tunnel by one or more fans or blowers, or a combination thereof, through one or more openings.

10) The method of claim 7, wherein air from inside the ignition-source-free heat tunnel is exhausted by one or more fans or blowers, or a combination thereof, through one or more openings into the room or exhausted to the outside.

11) An apparatus forming part of an automated coating system, which apparatus is a tunnel that is between about two feet and six feet in length, that is open at each end of such length through which the part or parts being coated in the automated coating system are transported, and which tunnel is free of any potential ignition source, that is, an ignition-source-free heat tunnel.

12) The apparatus of claim 11, wherein one or both of the open ends of the ignition-source-free heat tunnel are restricted in size so as to restrict air-flow and maintain heat within the ignition-source-free heat tunnel while at the same time allowing the part or parts on the automated coating system to pass through.

13) The apparatus of claim 11, wherein there are one or more openings in one or more of the side walls, or one or more of the end walls, or a combination thereof, of the ignition-source-free heat tunnel to ambient air.

14) The apparatus of claim 13, wherein one or more of the said openings may be closed, either fully or partially, through the use of one or more doors, gates or dampers, or a combination thereof.

15) The apparatus of claim 14, wherein one or more of the said doors, gates or dampers are controlled by one or more closed-loop feedback temperature control systems.

16) The apparatus of claim 11, wherein the ignition-source-free heat tunnel is insulated by conventional means.

17) The apparatus of claim 11, wherein heat is added to the ignition-source-free heat tunnel, where such heat is produced by one or more conventional heating technologies comprising at least one member from the group comprising of convection, resistive electrical, infra-red, near-infra-red, ultra-violet, microwave, and radio-frequency.

18) The apparatus of claim 17, wherein the part or parts to be coated on the automated coating system are formed by a pultruder, extruder or other forming device upstream of the automated coating system, and heat is supplied to the ignition-source-free heat tunnel using heated oil from the pultruder, extruder or other forming device, using one or more heat exchangers.

19) The apparatus of claim 17, wherein the heat supplied to the ignition-source-free heat tunnel is originally generated by a member selected from one or more of the pre-heat oven and the cure oven in the automated coating system, and supplied to the ignition-source-free heat tunnel as exhaust from one or more of the said heat sources.

20) The apparatus of claim 17, wherein heated air is moved into the ignition-source-free heat tunnel by one or more fans or blowers, or a combination thereof, through one or more openings to the ignition-source-free heat tunnel.

21) The apparatus of claim 20, wherein one or more of the said openings is controlled by one or more closed-loop feedback temperature control systems.

22) The apparatus of claim 17, wherein air from inside the ignition-source-free heat tunnel is exhausted by one or more fans or blowers, or a combination thereof, through one or more openings into the room or exhausted to the outside.

23) The apparatus of claim 22, wherein one or more of the said openings is controlled by one or more closed-loop feedback temperature control systems.
